(19) United States
(12) Patent Application Publication
(10) Pub. No.: US 2015/0106358 A1
(43) Pub. Date: Apr. 16, 2015

(54) SYSTEMS AND METHODS FOR CONVEYING SEARCH RESULTS WITHIN AN EMAIL APPLICATION

(71) Applicant: Google Inc., Mountain View, CA (US)

(72) Inventors: David Nachum, San Francisco, CA (US); Mate SZALAY, Zürich (CH); Balazs RACZ, Zürich (CH); Abraham MOOLENAAR, Zürich (CH)

(73) Assignee: Google Inc., Mountain View, CA (US)

(21) Appl. No.: 14/145,022

(22) Filed: Dec. 31, 2013

Related U.S. Application Data
(60) Provisional application No. 61/890,771, filed on Oct. 14, 2013.

(51) Int. Cl. G06F 17/30

(52) U.S. Cl. CPC G06F 17/30554
USPC 707/722

(57) ABSTRACT

Systems and methods for conveying search results at a computing device are provided. The systems and methods provide a user interface for an email application. The user interface comprises a search field. User entry of a portion of a search term, comprising at least one character, is detected in the search field. In response, a recommended search completion term is also displayed in the search field. The recommended search completion term comprises the portion of a search term. A plurality of search results is then displayed in a graphical overlay panel that is overlaid on a portion of the user interface. These search results are from a plurality of sources independently selected from the group consisting of: contact information, email messages, documents, calendar entries, email labels, recent searches and web searches.

### CROSS REFERENCE TO RELATED APPLICATION

This application claims priority to U.S. Provisional Patent Application No. 61/890,771, filed Oct. 14, 2013, entitled “System and Method for Conveying Search Results within an Email Application,” which is hereby incorporated by reference herein in its entirety.

### TECHNICAL FIELD

The implementations disclosed herein relate generally to displaying search results from at least two distinct sources, in an email application.

### BACKGROUND

Many email application users have information in other applications, such as calendar entries in a calendar application or documents in an online document storage application. These other sources of information are often connected to the user's email account (e.g., a user's Gmail account, and that user's GOOGLE Calendar account). Currently, if users wish to search for information in an email application, they can only retrieve results pertaining to the email application. Even results for different types of items in an email application may require separate searches (e.g., searching for email messages distinctly from searching for email labels). Searching the web for a term requires opening a distinct web search application to perform the search.

Providing a user with the ability to quickly and efficiently access search results across multiple applications has several challenges. Firstly, the method of conveying search results must be convenient. Users are reluctant to open another application to perform a comprehensive search when they wish to see search results from within an email application. Secondly, the search results must be organized to allow the user to effectively retrieve the result being sought.

The above identified technical problems are reduced or eliminated by the systems and methods disclosed herein.

### BRIEF DESCRIPTION OF THE DRAWINGS

The implementations disclosed herein are illustrated by way of example, and not by way of limitation, in the figures of the accompanying drawings. Like reference numerals refer to corresponding parts throughout the drawings.

FIG. 1 is an example block diagram illustrating a computing system, in accordance with some implementations.

FIG. 2 is an example block diagram illustrating a computing device, in accordance with some implementations.

FIG. 3 is an example block diagram illustrating a graphical overlay system, in accordance with some implementations.

FIGS. 4A-4J are example representations of a method for conveying search results, in accordance with some implementations.

FIGS. 5A-5D are example flow charts illustrating methods 500 for conveying search results, in accordance with some implementations.

### SUMMARY

Technical solutions (e.g., computing systems, methods, and non-transitory computer readable storage mediums) for conveying search results in an email application are provided in the present application.

In some embodiments, the method provides an intuitive way to convey search results from at least two sources in an email application. The method reduces the cognitive burden on a user when conveying search results from at least two sources, thereby creating a more efficient human-machine interface.

In some embodiments, the device displays a user interface for an email application, where the user interface comprises a search field. In some embodiments, the user interface further comprises a display board, where the display board lists a plurality of email messages. In some embodiments, the device detects user entry of a portion of a search term in the search field, where the portion of a search term comprises at least one character (e.g., at least one ASCII character).

In some embodiments, the device performs several operations in response to detecting user entry of the portion of a search term in the search field, as follows. The device displays a recommended search completion term. In some embodiments the recommended search completion term is shown directly in the search field. In some embodiments a plurality of recommended search completion terms are provided in a panel for selection of one such completion term by the user. In some embodiments, a recommended search completion term comprises the portion of a search term that has been entered by the user. Responsive to selection of a search completion term in instances where multiple such terms are presented, or without further user intervention in embodiments where only a single search completion term is provided, the device displays a plurality of search results in a graphical overlay panel responsive to the search completion term coupled with the partial search term. The graphical overlay panel is overlaid on a portion of the user interface. As used herein, the term “portion” means less than the entirety of a whole. The plurality of search results includes search results from a plurality of sources, including at least two sources selected from the group consisting of: contact information, email messages, documents, calendar entries, email labels, recent searches and web searches. In this way, advantageously, a user is able to obtain search results from multiple sources using a single partial query. In some embodiments, the search results are added to or removed from the plurality of search results in the graphical overlay panel on a dynamic basis in response to the addition or removal of characters from the portion of the search term in the search field entered by a user. In some embodiments, displaying the plurality of search results in the graphical overlay panel includes displaying a subset of the text from the content of a respective search result, for one or more search results in the plurality of search results.

In some embodiments, each instance of the portion of the search term is highlighted, or otherwise graphically offset or distinguished, in one or more search results in the plurality of search results displayed in the graphical overlay panel. In some embodiments, each instance of the recommended search completion term is highlighted, or otherwise graphically offset or distinguished, in one or more search results in the plurality of search results displayed in the graphical overlay panel. In some embodiments, at least a subset of the search results in the plurality of search results in the graphical overlay panel is ordered or reverse ordered by a respective date associated with each search result in the subset of search results. In some embodiments, the plurality of search results in the graphical overlay panel is grouped into two or more subsets, each subset in the two or more subsets uniquely representing a different source in the plurality of sources. In some embodiments, displaying the plurality of search results further comprises displaying a respective icon corresponding to the source for each respective search result in the plurality of search results.

In some embodiments, displaying the plurality of search results in the graphical overlay panel includes displaying a respective date associated with each search result in the subset of search results. In some embodiments, the graphical overlay panel has a degree of opacity between 30% and 99%. In some embodiments, the graphical overlay panel comprises affordances to allow sorting of the plurality of search results by source or by dates associated with search results in the plurality of search results. In some embodiments, the graphical overlay panel displays up to a predetermined number of search results, and comprises an affordance to allow for the display of additional search results.

In some embodiments, user selection of a respective search result in the plurality of search results is detected. In some embodiments, a determination is made as to whether the selected search result is associated with the email application. In some embodiments, in response to determining that the selected search result is associated with the email application, the search result is opened in the email application. In some embodiments, in response to determining that the selected search result is associated with a second application, distinct from the email application, the search result is opened in the second application. In some embodiments, one or more recommended search completion terms is displayed in the graphical overlay panel.

In other aspects of the present disclosure, computing systems and non-transitory computer storage mediums for executing one or more steps of any of the above-described methods are also disclosed.

### DETAILED DESCRIPTION

The implementations described herein provide various technical solutions to convey search results from at least two sources in an email application, and in particular to the above-identified problems. Details of implementations are now described in relation to the Figures.

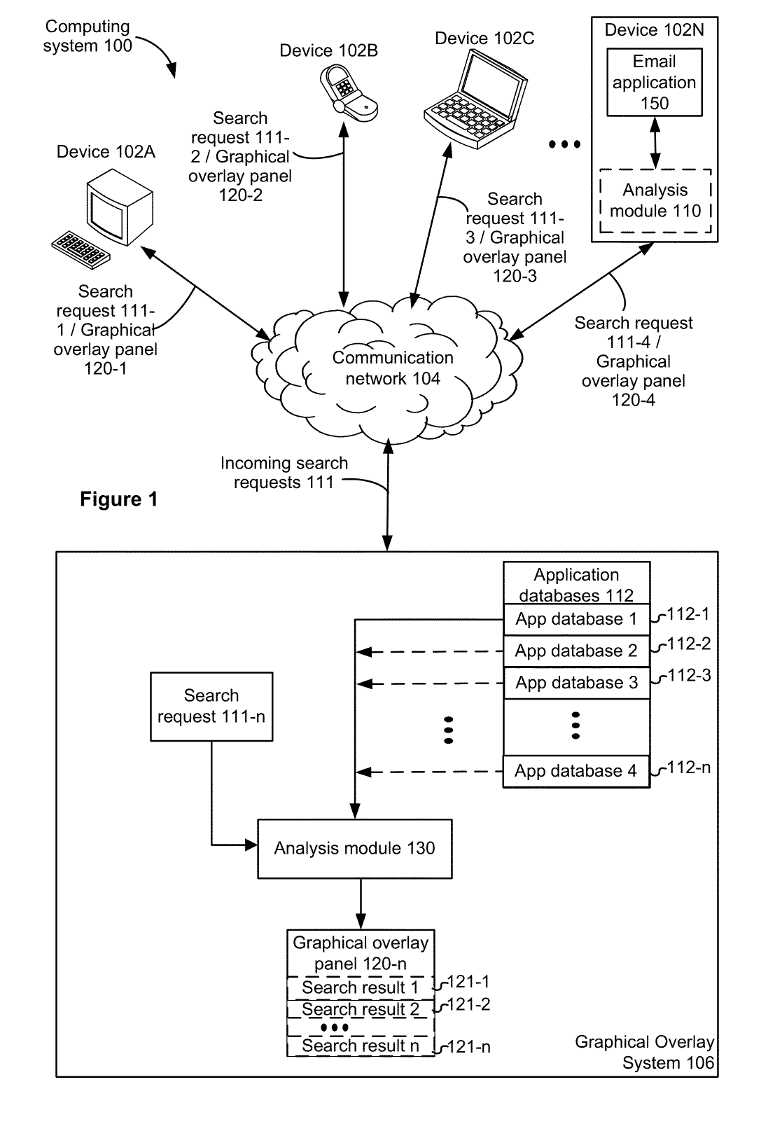

FIG. 1 is a block diagram illustrating a computing system 100, in accordance with some implementations.

In some implementations, the computing system 100 includes one or more devices 102 (e.g., device 102A, 102B, 102C, . . . , and 102N), a communication network 104, and a graphical overlay system 106. In some implementations, a device 102 is a portable electronic device (e.g., mobile phone or tablet) or a computer (mobile or otherwise).

In some implementations, a device 102 obtains a full or partial search request 111 from a user of the device 102, and transmits the partial search request 111 to the graphical overlay system 106 for determining search results from at least two sources, generating a graphical overlay panel and sending the graphical overlay panel information back to device 102.

In some implementations, a device 102 includes an email application 150 and optionally an analysis module 110 (similar to that included in the graphical overlay system 106). In some implementations, the email application 150 processes the user's full or partial search request from the device 102. In some implementations, the analysis module 110 resident on the device 102 determines what information to send to the graphical overlay system 106, or what information to interpret coming back from graphical overlay system 106. For example, after a user types the first letter of a search request (e.g., the letter “p”) in a search field in email application 150, the analysis module 110 on the device 102 determines that a search request is occurring and transmits the portion of the search request entered by a user (e.g., the letter “p”) to the graphical overlay system 106. The analysis module 110 on device 102 may also transmit other information, such as the email account identification or user identification. The analysis module 130 on graphical overlay system 106 processes the portion of a search request and the identification information, to determine a set of search results drawn from at least two distinct sources.

In some implementations, the communication network 104 interconnects one or more devices 102 with each other, and with the graphical overlay system 106. In some implementations, the communication network 104 optionally includes the Internet, one or more local area networks (LANs), one or more wide area networks (WANs), other types of networks, or a combination of such networks.

In some implementations, the graphical overlay system 106 includes an analysis module 130, a set of application databases 112, and the graphical overlay panel 120 to be generated.

In some implementations, the analysis module 130 interprets the search request 111, draws results from various distinct application databases 112-1 to 112-n, determines which results to convey to the user and generates a graphical overlay panel 120 comprising search results 121-1 to 121-n, where the search results originate from at least two distinct sources (e.g., app databases 112-1 to 112-n). In some implementations, graphical overlay system 106 transmits the graphical overlay panel 120 information back to device 102.

In some implementations, the analysis module 110 is a software or hardware component resident on the device 102, such as a software package/application or a hardware chipset, for processing search requests. In other implementations, the analysis module 110 is a separate or independent module from the device 102 (e.g., a GOOGLE mail clustering/processing server that is connected with but not part of the device 102).

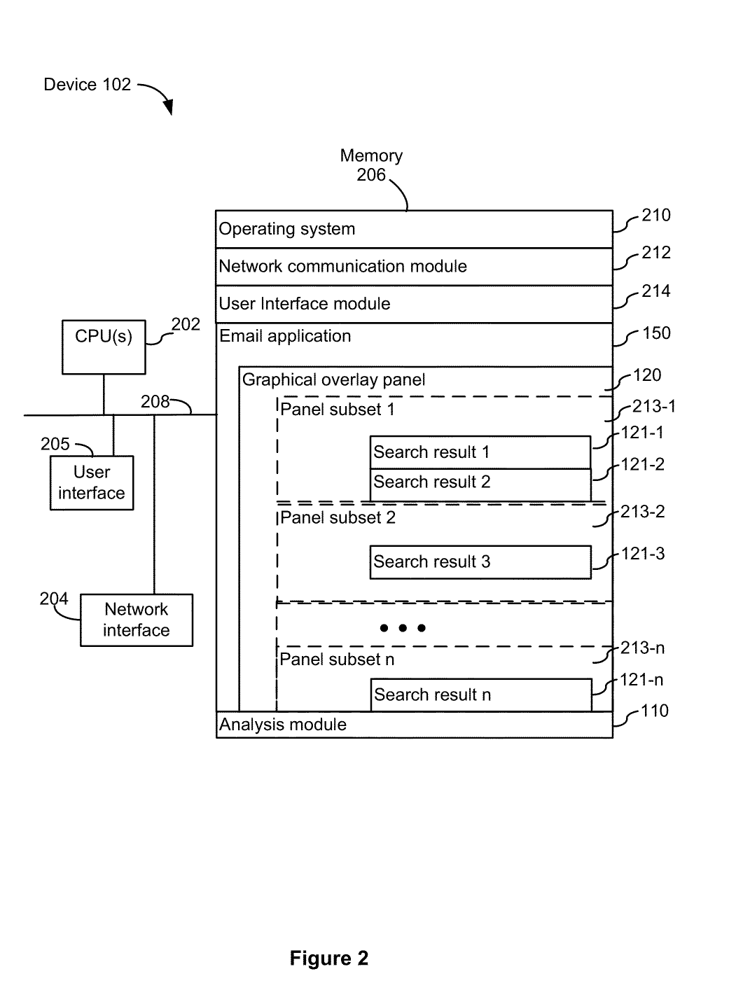

FIG. 2 is a block diagram illustrating a computing device 102, in accordance with some implementations. The device 102 in some implementations includes one or more processing units CPU(s) 202 (also referred to as processors), one or more network interfaces 204, a user interface 205, a memory 206, and one or more communication buses 208 for interconnecting these components. The communication buses 208 optionally include circuitry (sometimes called a chipset) that interconnects and controls communications between system components. The memory 206 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 206 optionally includes one or more storage devices remotely located from the CPU(s) 202. The memory 206, or alternatively the non-volatile memory device(s) within the memory 206, comprises a non-transitory computer readable storage medium. In some implementations, the memory 206 or alternatively the non-transitory computer readable storage medium stores the following programs, modules and data structures, or a subset thereof:
an operating system 210, which includes procedures for handling various basic system services and for performing hardware dependent tasks;
a network communication module (or instructions) 212 for connecting the device 102 with other devices (e.g., the graphic overlay module 106 and the devices 102B . . . 102N) via one or more network interfaces 204 (wired or wireless), or the communication network 104 (FIG. 1);
a user interface module 214 for displaying user interface components or controls (e.g., textbox, button, radio button, drop-down list) to a user;
an email application 150 for processing and displaying incoming and outgoing electronic messages, e.g., using cluster graphics, including:
   a graphical overlay panel 120 that optionally visually clusters (e.g., groups together) search results from a first application, such as search result 1 (121-1) and search result 2 (121-2), both of which have been assigned to panel subset 1;
   an optional panel subset 2 (213-2) in graphical overlay panel 120 that visually clusters (e.g., groups together) search results from a second application such as search result 3, which has been assigned to panel subset 2 (213-2); and
   an optional panel subset n (213-n) that visually clusters (e.g., groups together) search results that have been assigned to message cluster n; and
an analysis module 110 for analyzing outgoing search requests and incoming graphical overlay panel 120 information.

In some implementations, the user interface 205 includes an input device (e.g., a keyboard, a mouse, a touchpad, a track pad, and a touch screen) for a user to interact with the device 102.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 206 optionally stores a subset of the modules and data structures identified above. Furthermore, the memory 206 may store additional modules and data structures not described above.

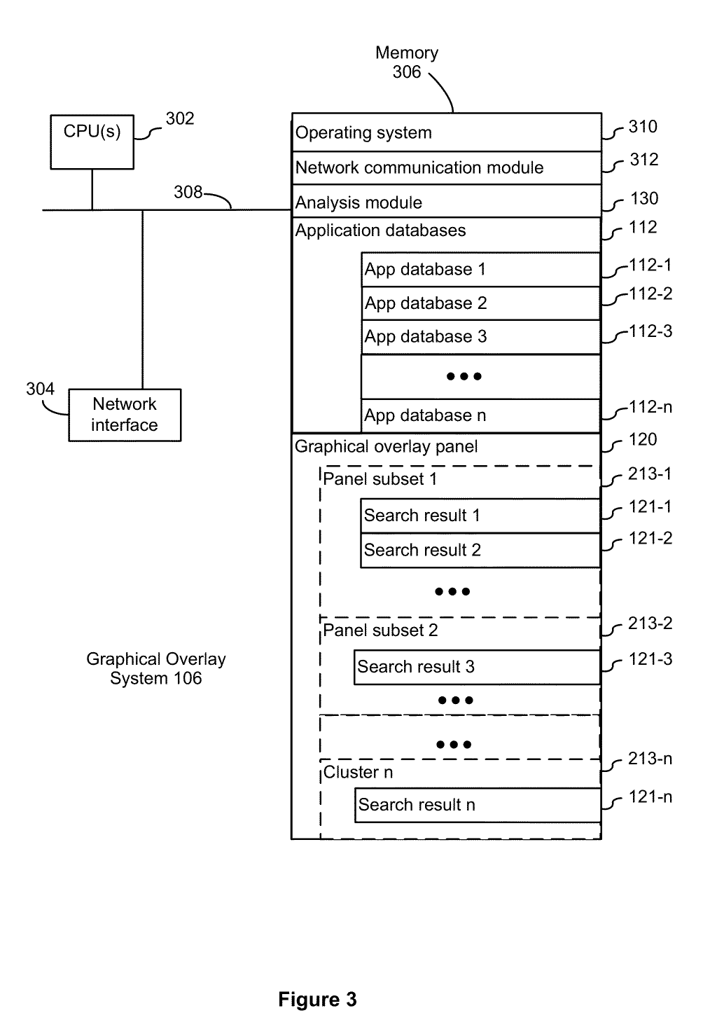

FIG. 3 is a block diagram illustrating a graphical overlay system 106, in accordance with some implementations. The graphical overlay system 106 typically includes one or more processing units CPU(s) 302 (also referred to as processors), one or more network interfaces 304, memory 306, and one or more communication buses 308 for interconnecting these components. The communication buses 308 optionally include circuitry (sometimes called a chipset) that interconnects and controls communications between system components. The memory 306 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 306 optionally includes one or more storage devices remotely located from CPU(s) 302. The memory 306, or alternatively the non-volatile memory device(s) within the memory 306, comprises a non-transitory computer readable storage medium. In some implementations, the memory 306 or alternatively the non-transitory computer readable storage medium stores the following programs, modules and data structures, or a subset thereof:
an operating system 310, which includes procedures for handling various basic system services and for performing hardware dependent tasks;
a network communication module (or instructions) 312 for connecting the graphical overlay system 106 with other devices (e.g., the devices 102) via the one or more network interfaces 304 (wired or wireless), or the communication network 104 (FIG. 1);
an analysis module 130 for analyzing incoming search requests and generating outgoing graphical overlay panel information; and
a plurality of application databases 112 comprising information awaiting retrieval and processing by the analysis module 130.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 306 optionally stores a subset of the modules and data structures identified above. Furthermore, the memory 306 may store additional modules and data structures not described above.

Although FIGS. 2 and 3 show a “device 102” and a “graphical overlay system 106,” respectively, FIGS. 2 and 3 are intended more as functional description of the various features which may be present in computer systems than as a structural schematic of the implementations described herein. In practice, and as recognized by those of ordinary skill in the art, items shown separately could be combined and some items could be separated.

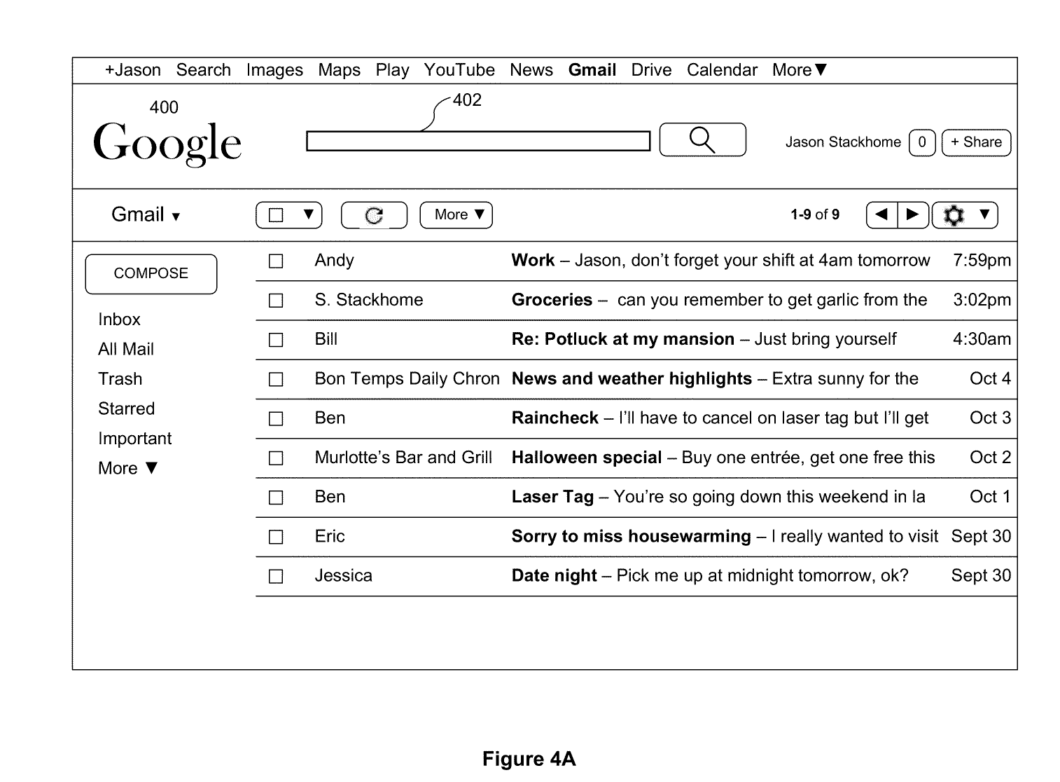

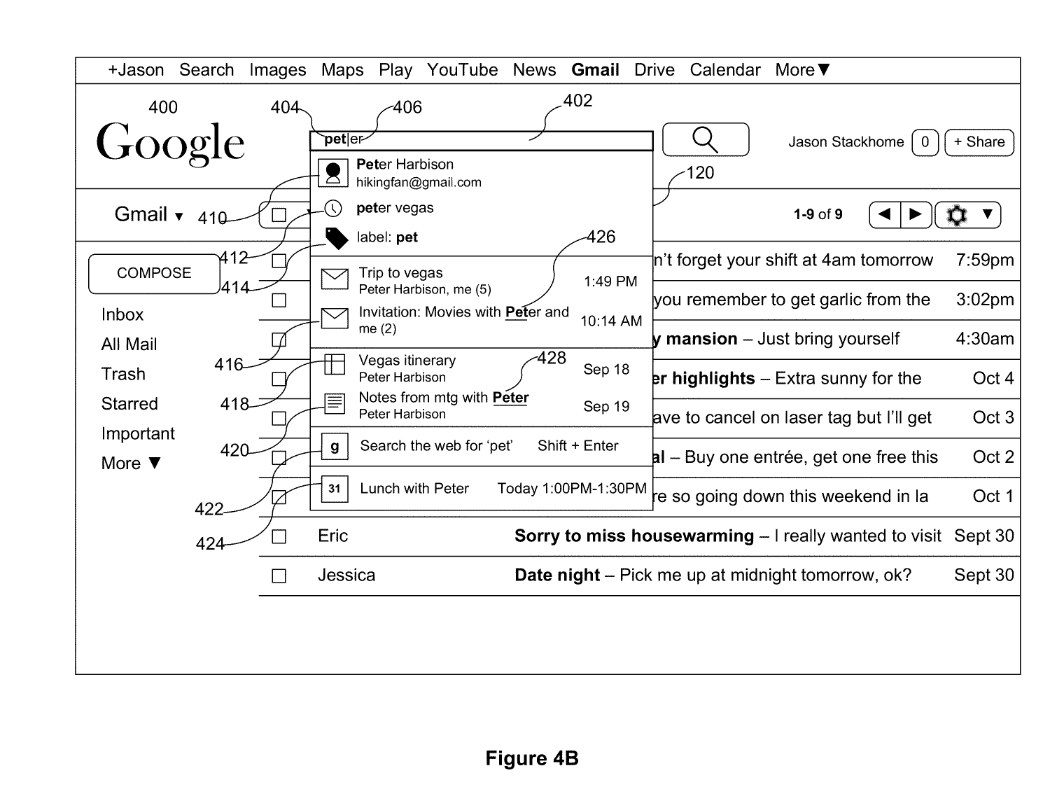

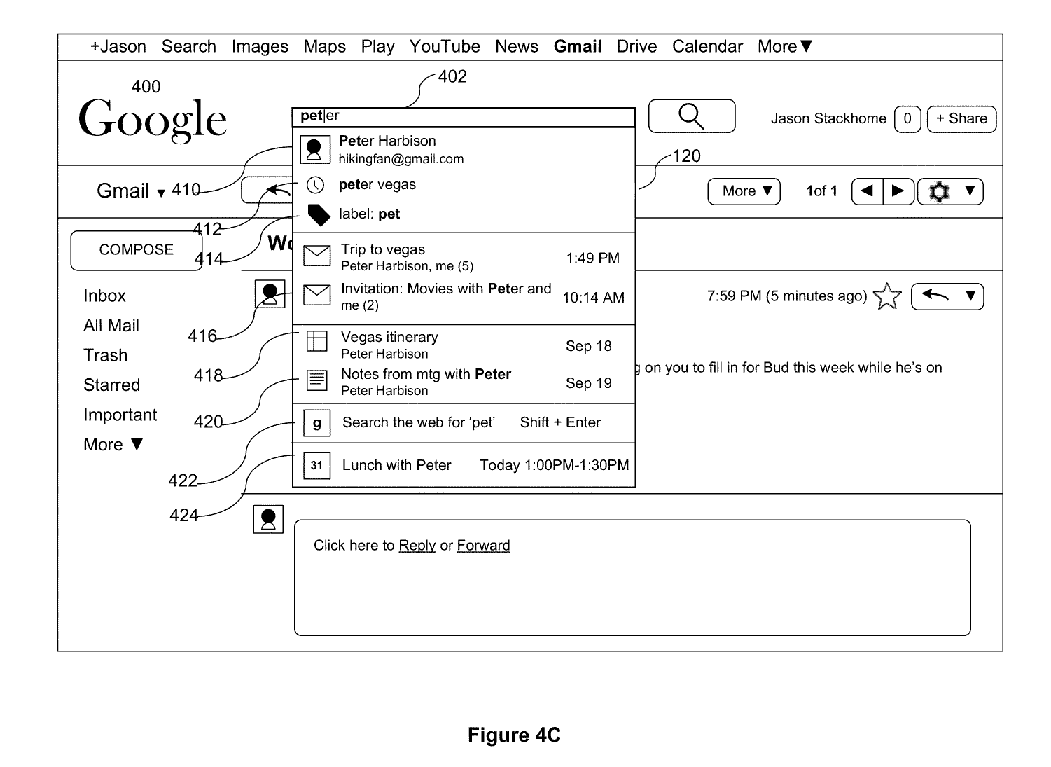

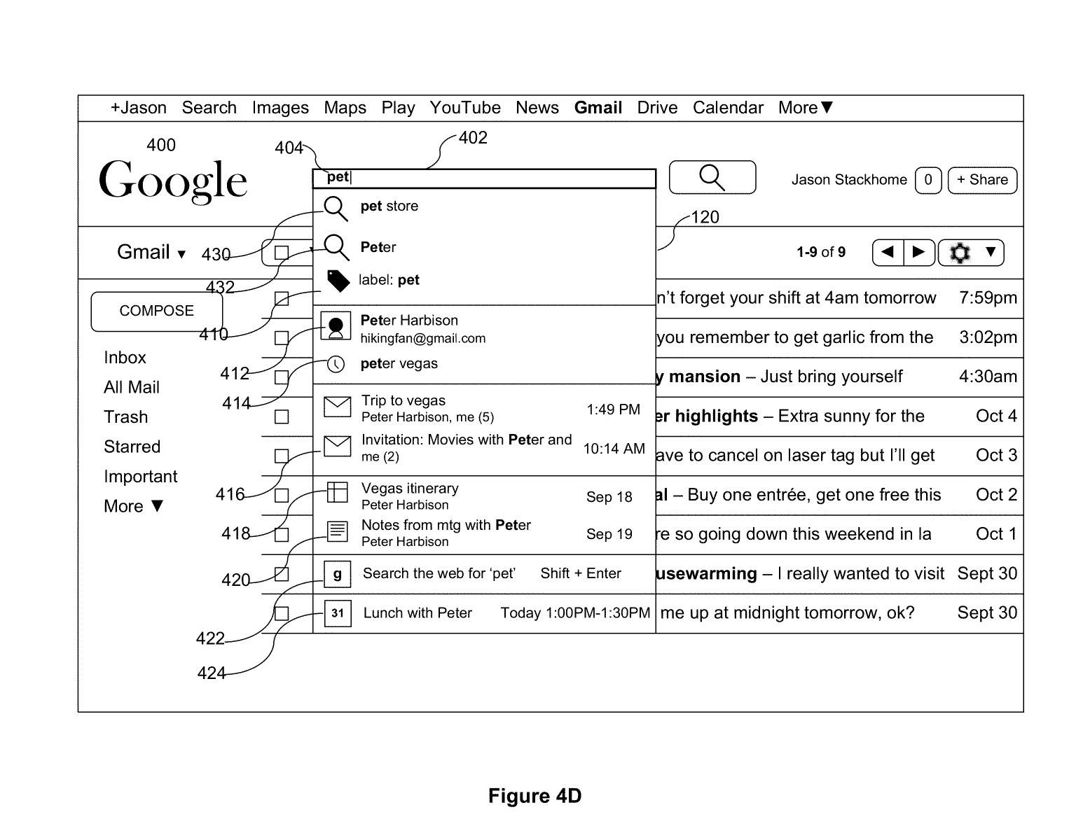

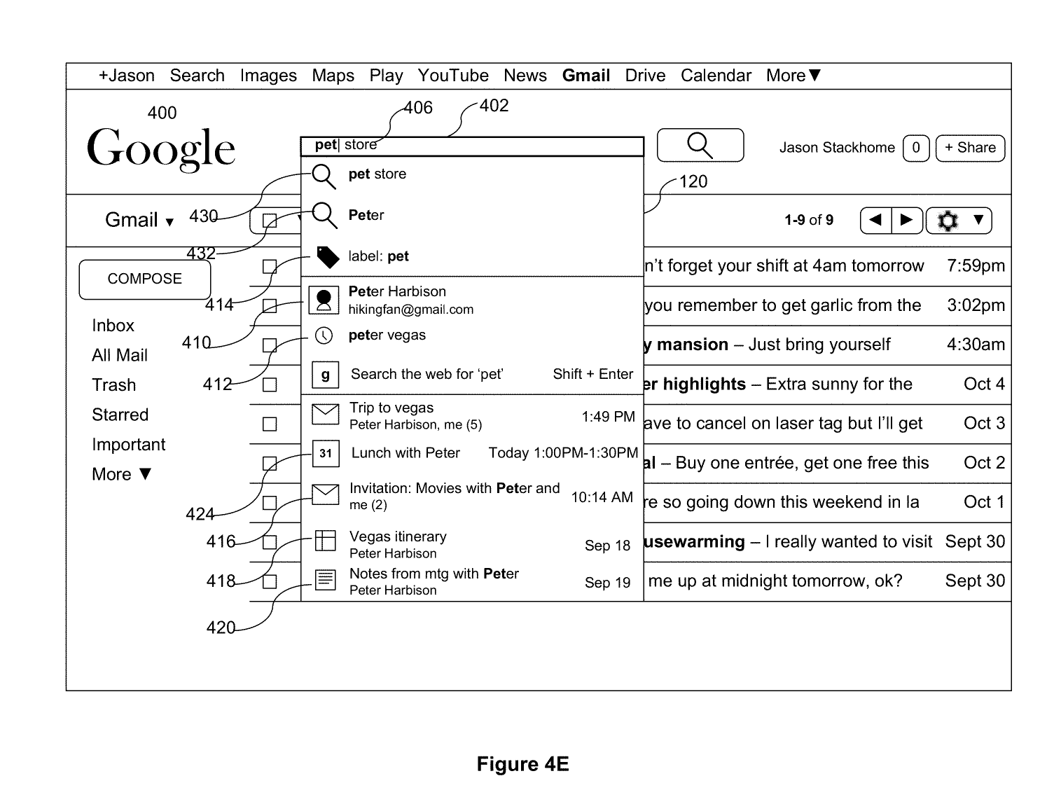

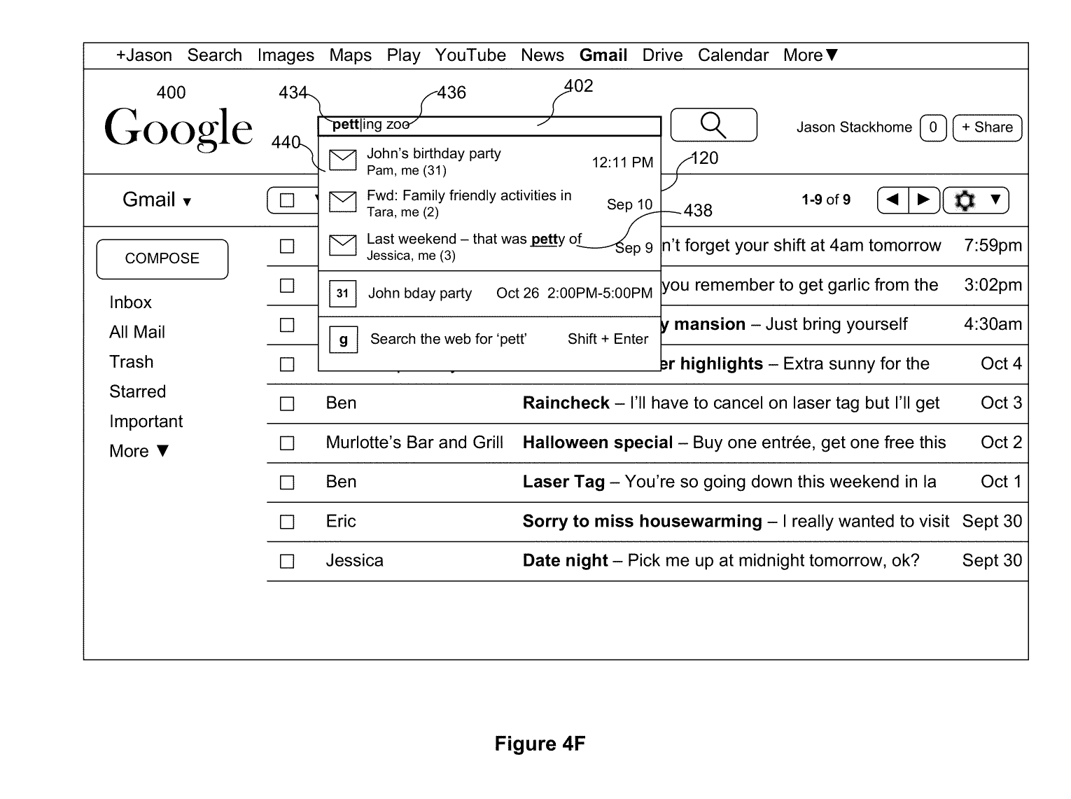

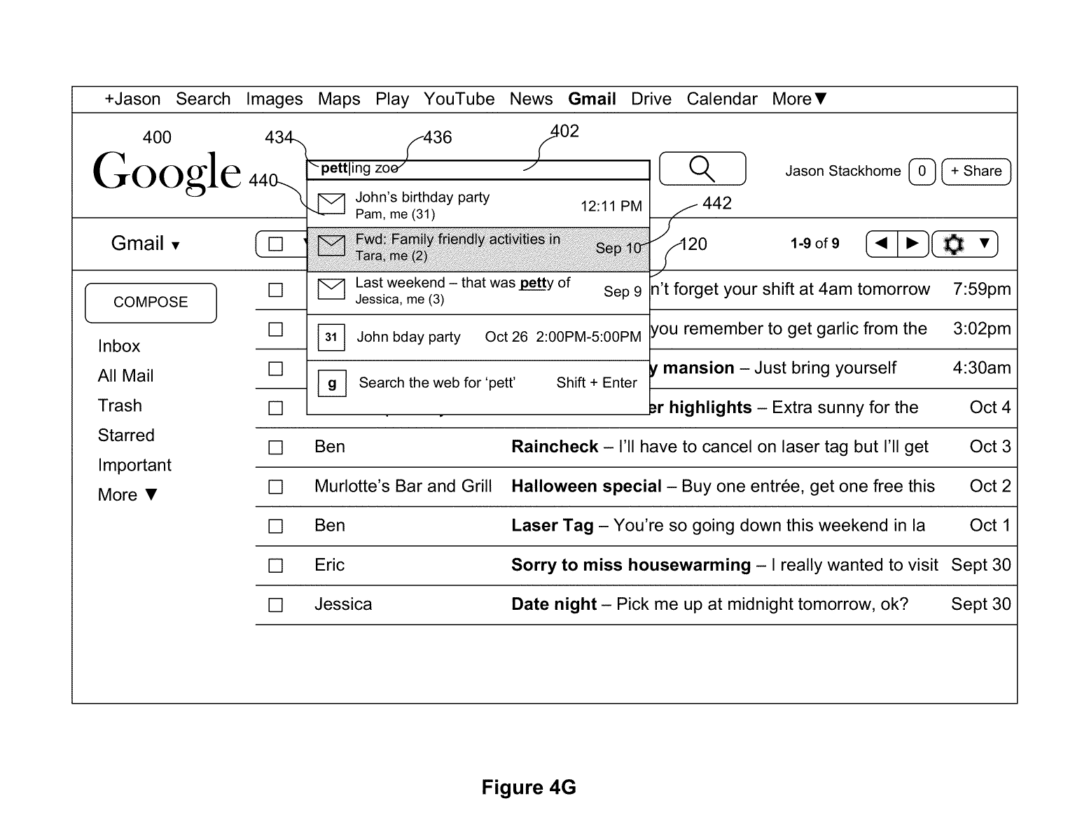

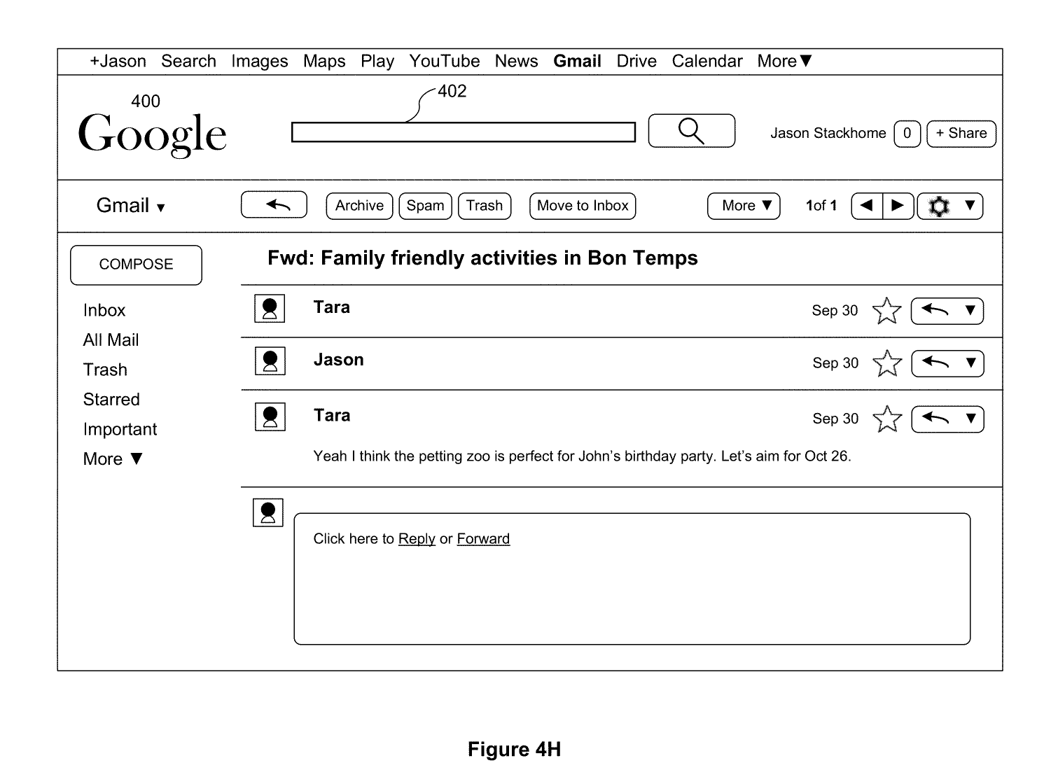

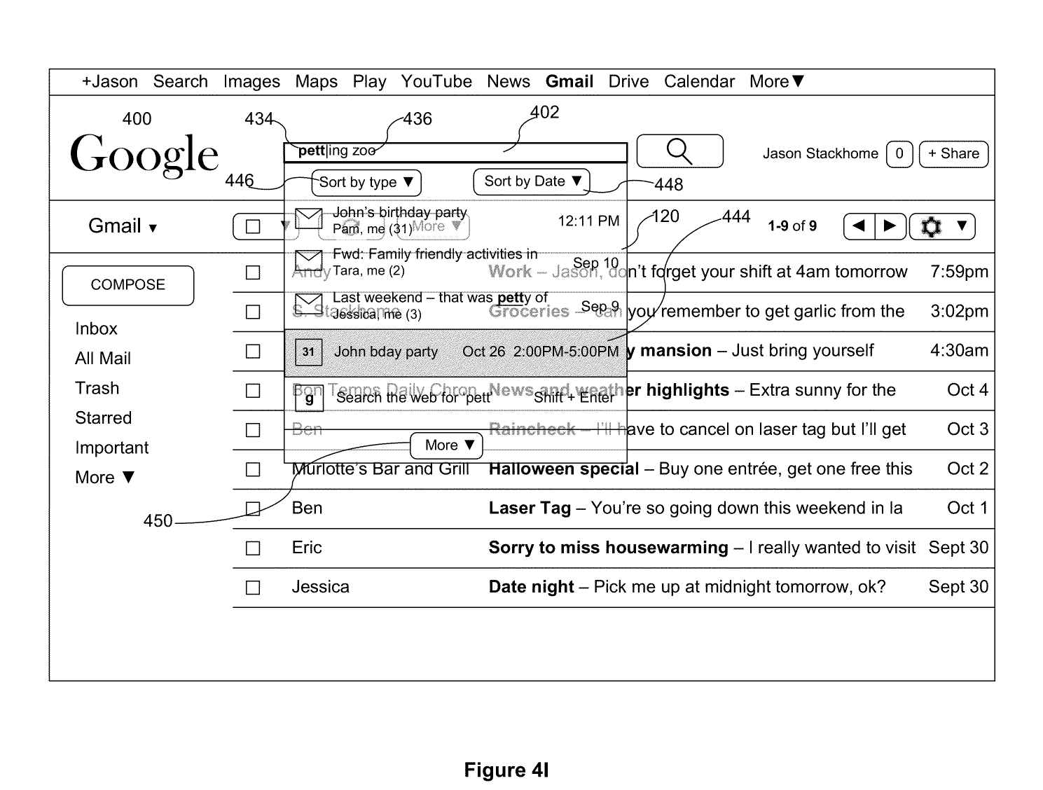

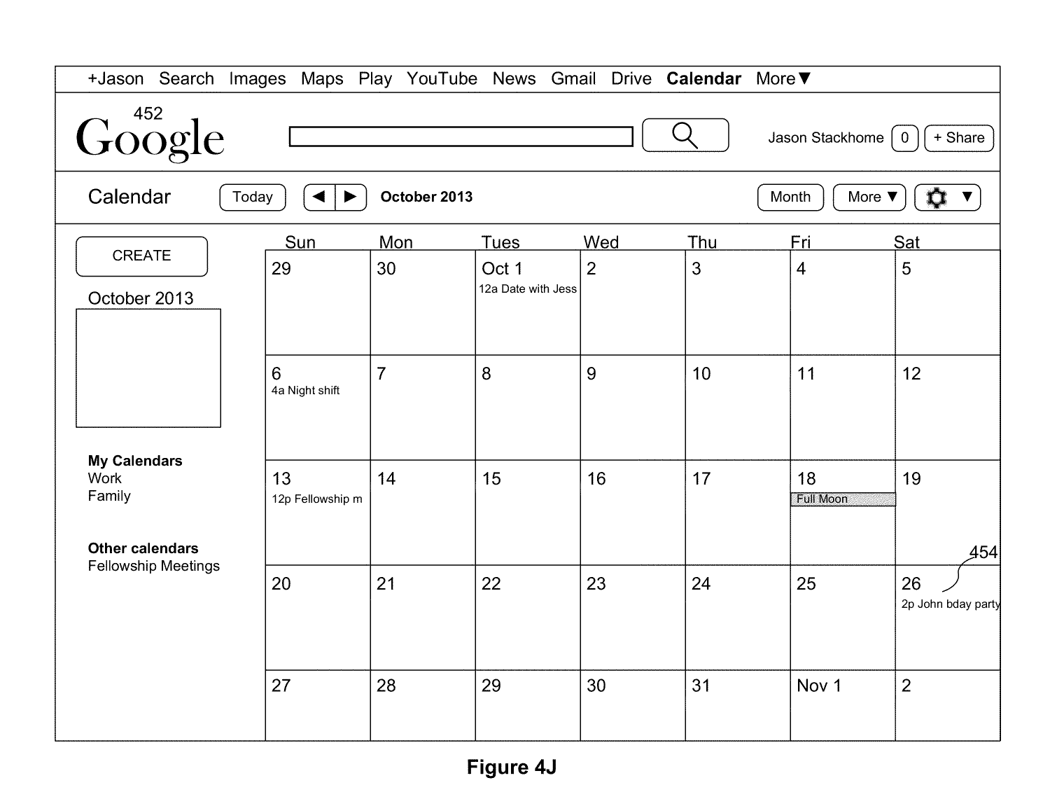

FIGS. 4A-4J are exemplary representations of a method for conveying search results, in accordance with some implementations. FIG. 4A illustrates a user interface 400 for an email application, comprising a search field 402 (e.g., a bar or a box to type search queries into). In some embodiments, user interface 400 further comprises a display board, where the display board lists a plurality of email messages (e.g., an inbox for an email application, or the contents of a folder in an email application). In some embodiments, the user interface 400 comprises a view of only one email message, or only one email conversation consisting of a plurality of email messages. In some embodiments, the user interface 400 comprises a view of any combination of one or email messages, one or more email conversations and/or one or more clusters. Clusters are described in U.S. patent application Ser. No. ______, attorney docket No. GP-19545-00 (060963-5974-US), filed ______, entitled “Systems and Methods for Clustering Electronic Messages,” which is hereby incorporated by reference herein in its entirety. Whereas conversations aggregate electronic messages based on content relatedness (e.g., header content relatedness) between messages already in the conversations and messages being considered for assignment to conversations, electronic messages are organized into clusters without regard to content relatedness between messages within the clusters and messages being considered for assignment to the clusters. For example, a string of messages from and to a first and second user or group of users are good candidates for inclusion in a conversation because of the content relatedness between the messages in the conversations and the messages being considered for the conversations. However, absent some additional criterion or factor, the relatedness in the source and destination of these messages does not serve as a basis for inclusion in the same cluster. In some embodiments, user interface 400 comprises a view of settings for an email application. User interface 400 can comprise any view of a feature consistent with an email application.

FIG. 4B illustrates user entry of a portion of a search term 404, in search field 402 (e.g., a user typing the letters “pet” into the search field 402). In some embodiments, the portion of a search term comprises alphanumeric characters, and in some embodiments the portion of a search term further comprises non-alphanumeric characters, such as punctuation marks, spaces or symbols. In response to detecting the portion of a search term 404 in the search field 402, in some embodiments, a recommended search completion term 406 is displayed in the search field 402. In some embodiments, that than providing a single search completion term 406, a plurality of search completion terms is provided in a panel and the user selects from among the plurality of search completion terms a single search completion term. In some embodiments, the portion of a search term 404 is displayed distinctly from the recommended search completion term 406 (e.g., by displaying the two terms in different colors or sizes, or displaying one term in bold text).

FIG. 4B further illustrates that in response to detecting the portion of a search term 404 in the search field 402, in some embodiments, a graphical overlay panel 120 is displayed. Graphical overlay panel 120 is overlaid on a portion of the user interface 400. In some embodiments, this includes being overlaid on top of a portion of a list of a plurality of email messages, as shown in FIG. 4B. If user interface 400 of an email application comprises a view of a single email message or a single email message conversation thread, graphical overlay panel 120 is overlaid on that single email message or single email message conversation thread. Graphical overlay panel 120 comprises a plurality of search results associated with the portion of a search term 404. The plurality of search results (e.g., 410, 412, 414, 416, 418, 420, 422 and 424), are drawn from at least two sources (e.g., contact information 410 and calendar entries 424). Search result 410 corresponds to contact information for a contact (e.g., a person or an entity). In some embodiments, contact information comprises a name, an email address, a telephone number, a physical address, a website or any combination thereof. In some embodiments, search result 410 comprises an icon corresponding to the search result being drawn from a database or collection of contact information (e.g., a photo of the contact, a generic logo associated with a contact or a graphic associated with the specific contact).

In FIG. 4B, the exemplary graphical overlay panel 120 comprises a recent search term 412. In some embodiments, recent search term 412 corresponds to a search term entered in the search field 402 within a predetermined time period (e.g., within the last 24 hours). In some embodiments, recent search term 412 corresponds to a search term entered in the search field 402 within a predetermined number of recent searches (e.g., one of the last five search terms entered in search field 402). In some embodiments, search result 412 comprises an icon corresponding to the search result being drawn from a database or collection of recent searches (e.g., a symbol of a clock).

In FIG. 4B, the exemplary graphical overlay panel 120 comprises an email label 414. In some embodiments, email label 414 corresponds to a user-generated label for categorizing email messages (e.g., the label “pet” is applied to all messages relating to the email user's domesticated animal). In some embodiments, email label 414 comprises an icon corresponding to the search result being drawn from a database or collection of email labels (e.g., a symbol of a paper label for a package, or a letter “L”).

In FIG. 4B, the exemplary graphical overlay panel 120 comprises email message search results 416. In some embodiments, email message search result 416 corresponds to an email message from the user's email account (e.g., Invitation: Movies with Peter and . . . ). In some embodiments, the email message search result 416 corresponds to an email message conversation comprising more than one email message. In some embodiments, the email message search result 416 corresponds to a cluster that itself comprises one or more electronic messages, conversations, or sub-clusters. As used herein, the term sub-cluster refers to a cluster that is embedded in a cluster. That is to say, clusters can have parent child hierarchy where the parent cluster represents some broad category or set of clustering rules and the child cluster a more specific category and/or a set of more specific clustering rules. In some embodiments, email message search result 416 comprises an icon corresponding to the search result being drawn from a database or collection of email messages (e.g., a symbol of an envelope). In some embodiments, the email message search result 416 displays the title of the corresponding email message, the author or authors of the corresponding email message or messages, the date and/or time of the corresponding email message, a subset of the text of the corresponding email message or messages or any combination thereof. In some embodiments, email message search result 416 comprises an icon corresponding to the search result being drawn from a database or collection of email messages (e.g., a symbol of an envelope). In some embodiments, the icon indicates if the email message or email message conversation comprises one or more unread email messages, or if all email messages corresponding to email message search result 416 have been read.

In FIG. 4B, the exemplary graphical overlay panel 120 further comprises document search results 418 and 420. In some embodiments, document search results 418 and 420 correspond to documents from the email account user's online document storage (e.g., Google drive documents or from a cloud-based document storage account). In exemplary graphical overlay panel 120, document search result 418 corresponds to a spreadsheet document and document search result 420 corresponds to a word processing document. Document search results in graphical overlay panel 120 can also comprise presentation documents (e.g., a slideshow-style document), or other documents comprising at least a subset of text, such as a pdf (portable document format) file. In some embodiments, the document search result 416 displays the title of the corresponding document, the author or administrators of the corresponding document, the date and/or time of the corresponding document, a subset of the text of the corresponding document or any combination thereof. In some embodiments, document search result 416 comprises an icon corresponding to the search result being drawn from a database or collection of documents (e.g., a symbol of a spreadsheet, a symbol of a word processing document, a symbol of a presentation document or a trademarked logo for a proprietary document type). In some embodiments, the icon indicates if the document has been updated or changed since the user last viewed it.

In FIG. 4B, the exemplary graphical overlay panel 120 comprises web search request 422, where a web search request 422 corresponds to a request to search for the portion of a search term 404 (e.g., pet), in a web search engine (e.g., Google web search). In some embodiments, graphical overlay panel 120 always comprises one or more web search requests 422. In some embodiments, a web search request 422 can have a keyboard shortcut (e.g., entering Shift Key plus the Enter key) to launch a web search for the portion of a search term 404. In some embodiments, one or more web search requests 422 correspond to requests to search the web for the recommended search completion term 406.

In FIG. 4B, the exemplary graphical overlay panel 120 further comprises calendar entry search result 424. In some embodiments, calendar entry search result 424 corresponds to a calendar entry in one or more of the email account user's associated calendars (e.g., a calendar entry for a lunch meeting with Peter in Jason's associated Google Calendar account). In some embodiments, the calendar entry search result 424 displays the title of the corresponding calendar entry, the date and/or time of the corresponding calendar entry, the particular calendar associated with the calendar entry (e.g., work calendar, social calendar), a location corresponding to the calendar entry or any combination thereof. In some embodiments, calendar entry search result 424 comprises an icon corresponding to the search result being drawn from a database or collection of calendar entries (e.g., a symbol of a page in a calendar). In some embodiments, the icon indicates the particular calendar that the calendar entry corresponds to (e.g., work calendar, social calendar).

In FIG. 4B, the exemplary graphical overlay panel 120 displays the highlighting of the portion of the search term 426 in each of the search results. In some embodiments, the graphical overlay panel 120 displays the recommended search completion term 428 highlighted in the search results. FIG. 4B also illustrates that in some embodiments, graphical overlay panel 120 groups search results by their respective sources (e.g., email message search results 416 are grouped together, and document search results 418 and 420 are grouped together). In some embodiments, graphical overlay panel 120 further organizes search results within groups on an ordered basis, such as alphabetical, chronological or most recently viewed.

FIG. 4C illustrates another view of user interface 400 for an email application, comprising a view of an exemplary single email message, with graphical overlay panel 120 overlaid on user interface 400 and a portion of the exemplary single email message.

FIG. 4D illustrates an exemplary graphical overlay panel 120 comprising recommended search terms 430 and 432. In some embodiments, graphical overlay panel 120 comprises one or more distinct recommended search terms (e.g., terms 430 and 432). In some embodiments, these recommended search terms 430 and 432 comprise the portion of a search term 404. In some embodiments the recommended search term comprises a word or phrase related to the portion of a search term 404 (e.g., if the user only typed the letter “p”, a recommended search completion term may include terms most frequently searched for by the user, starting with the letter “p”). In some embodiments, recommended search terms 430, 432 are displayed in graphical overlay panel 120 in combination with displaying a recommended search completion term (e.g., term 406 in FIG. 4B) in the search field 402.

FIG. 4E illustrates an exemplary graphical overlay panel 120 displaying at least a subset of search results ordered by a respective date associated with each search result in the subset of search results. For example, in FIG. 4E, calendar entry search result 424 (e.g., with a date of 1:00 PM) is displayed above email message search result 416 (e.g., with the same date and a time of 10:14 AM), which is displayed above document search result 418 (e.g., with a prior date of September 18). In some embodiments, the subset of search results with an associated date and time are displayed in a reverse chronological order (e.g., from oldest to most recent). In some embodiments, search results that do not have an associated date or time (e.g., contact information, recent search terms or email labels) are grouped distinctly from the search results with an associated respective date.

FIG. 4F illustrates the dynamic nature of the recommended search completion terms 436 in search field 402 and the graphical overlay panel 120. In FIG. 4F, the portion of a search term 434 differs from the portion of a search result 404 (e.g., “pet” in FIGS. 4B-4E), for example, if a user entered an extra letter “t” after already typing “pet” in search field 402. As can be seen in graphical overlay panel 120 in FIG. 4F, in response to detecting the portion of a search term 434 (e.g., “pett”), the graphical overlay panel 120 comprises a different set of search results than it did in response to detecting the portion of a search term 404 (e.g., “pet”). In some embodiments, one or more of the search results in graphical overlay panel 120 will be the same in response to detection of different portions of a search term (e.g., 404 or 434) in search field 402. FIG. 4F also illustrates an exemplary embodiment of an email message search result 438 in graphical overlay panel 120, comprising a subset of the text of the corresponding email message. In this example, it is shown that the portion of a search term 434 is highlighted in the subset of the text of the corresponding email message in email message search result 438. In some embodiments, one or more of the search results displayed in graphical overlay panel 120 do not display the portion of a search term (e.g., 434) in graphic overlay panel 120 (e.g., email search result 440 does not show “pett”). This illustrates that some search results may be displayed in graphical overlay panel 120 based on words in the content of the corresponding item (e.g., the email message corresponding to email search result 440 may contain a word with the letters “pett”).

FIG. 4G illustrates detection of user selection of a search result in the graphical overlay panel 120 (e.g., selection of email message search result 442). In some embodiments, upon detection of a user search result in graphical overlay panel 120, the search result is highlighted (e.g., email message search result 442 is displayed as being highlighted in FIG. 4G). Some of the search results in graphical overlay panel 120 are associated with an email application (e.g., contact information, email messages, email labels), and some of the search results in graphical overlay panel 120 are associated with a different application (e.g., calendar entry, web search, document).

FIG. 4H illustrates the response to detection of a user selection of email message search result 442 in FIG. 4G. In some embodiments, in response to determining that the user selected a search result in graphical overlay 408 that is associated with the email application, the search result is opened in the email application.

FIG. 4I illustrates detection of user selection of a search result in the graphical overlay panel 120 (e.g., selection of calendar entry search result 444). The graphical overlay panel 120 in FIG. 4I also illustrates that in some embodiments, graphical overlay panel 120 has a varying degree of opacity (e.g., anywhere from 30% to 99% or anywhere from 30% to 100%). In some embodiments, graphical overlay panel 120 comprises affordances, such as affordance 446 or affordance 448, to allow sorting of the plurality of search results by source (or type) or by dates associated with search results in the plurality of search results. In some embodiments, graphical overlay panel 120 comprises one or more affordances to allow for sorting of the search results on another basis. In some embodiments, graphical overlay panel 120 displays up to a predetermined number of search results (e.g., the five search results shown in FIG. 4I), and comprises an affordance 450 to allow display of additional search results.

FIG. 4J illustrates the response to detection of a user selection of calendar entry search result 444 in FIG. 4I. In some embodiments, in response to determining that the user selected a search result in graphical overlay 408 that is associated with a second application, distinct from the email application, the search result is opened in the second application. In FIG. 4J, user interface 452 illustrates a calendar application, distinct from the email application. User interface 452 for the calendar application, illustrates calendar entry 454 that corresponds to calendar entry search result 444 from FIG. 4I. In some embodiments, in response to determining that the user selected a search result in graphical overlay 408 that is associated with a second application, distinct from the email application, the search result is opened in one of a plurality of user interfaces of the second application. For example, if the user selected a calendar entry search result, detection of that user selection could launch the calendar application with a monthly-view comprising that corresponding calendar entry (e.g., as shown in FIG. 4J), or it could show a weekly-view comprising that corresponding calendar entry, or another view. In some embodiments, the corresponding item to the user selected search result is highlighted or visibly distinguished from other items.

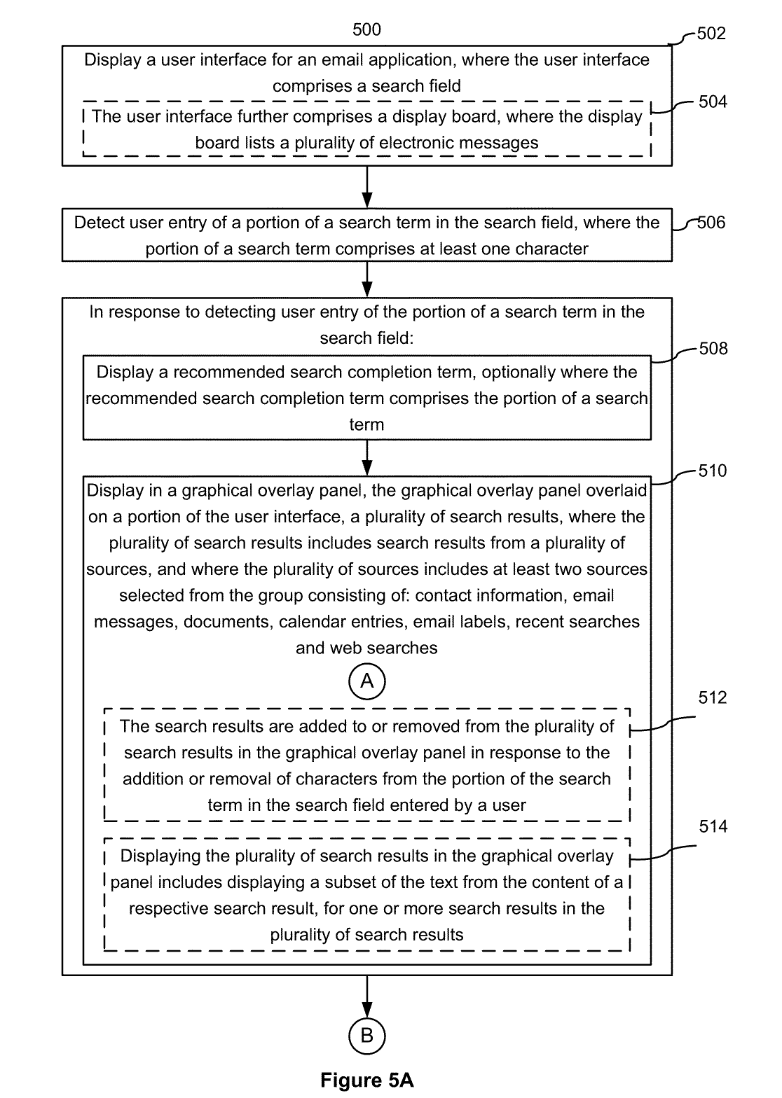

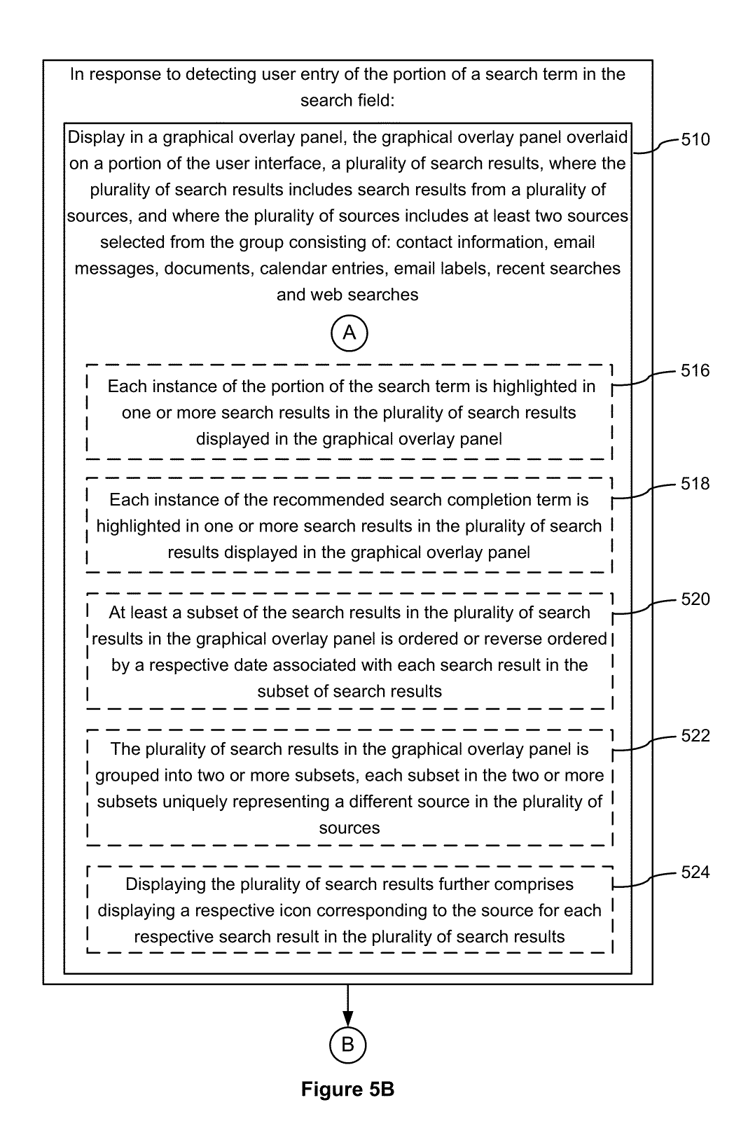

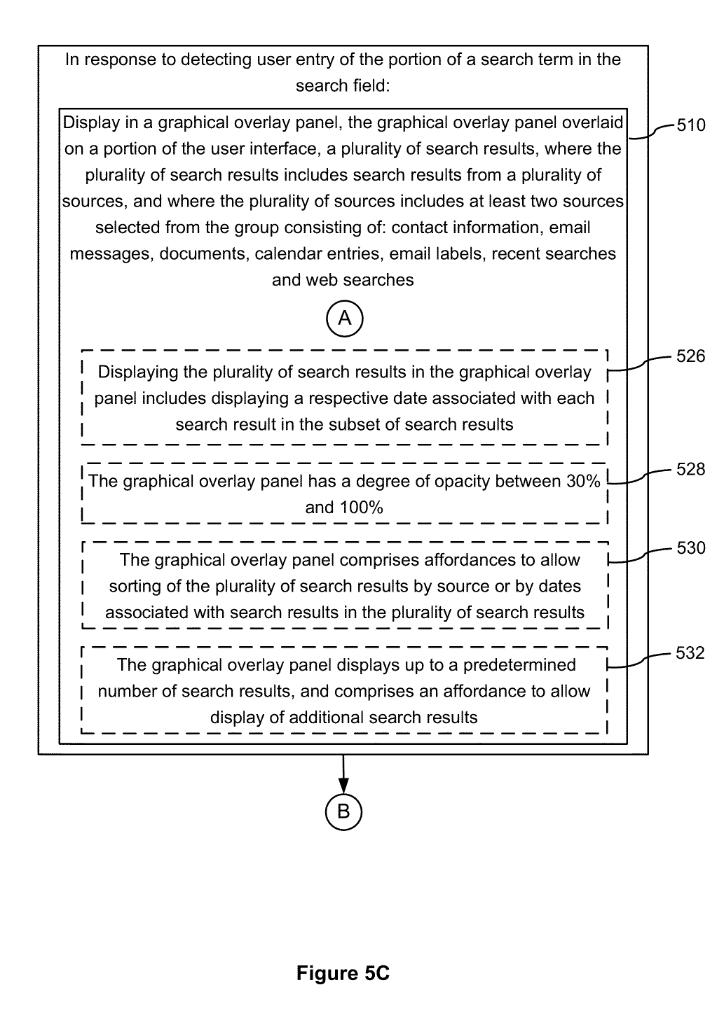

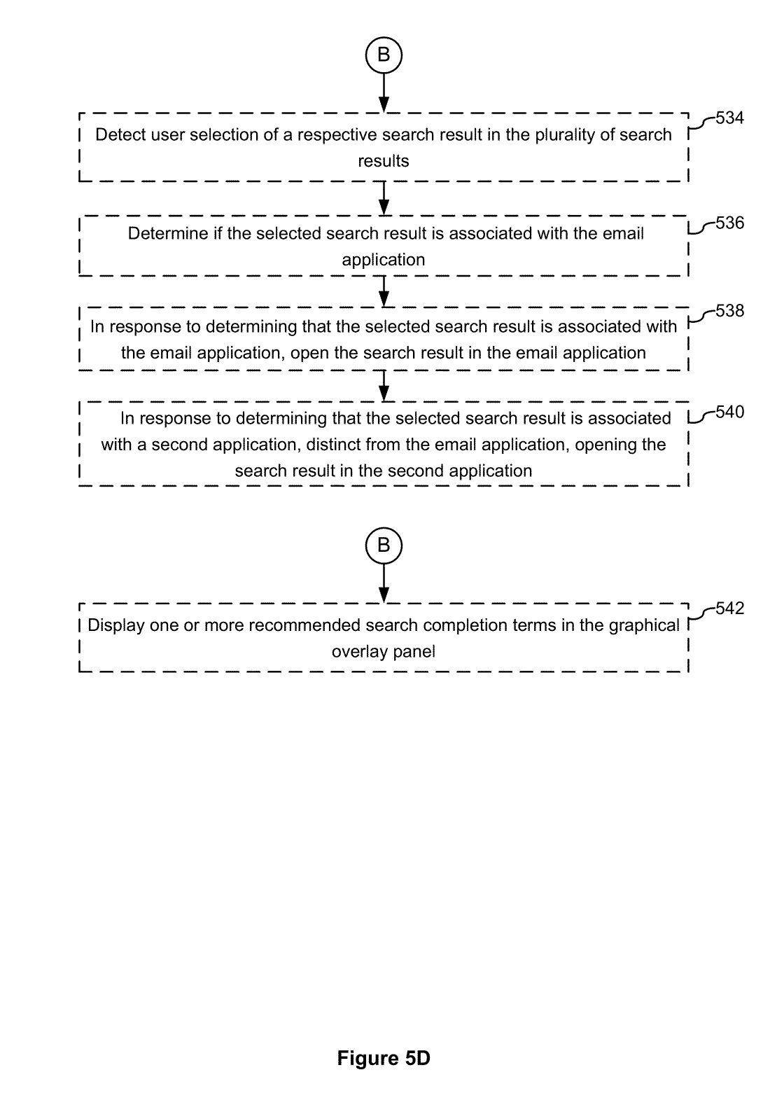

FIGS. 5A to 5D are flow diagrams illustrating an exemplary method 500 for conveying search results in a computing system (e.g., implemented at device 102), in accordance with some embodiments. Some operations in method 500 are, optionally, combined and/or the order of some operations is, optionally, changed.

As described below, the method 500 provides an intuitive way to convey search results from at least two sources in an email application. The method reduces the cognitive burden on a user when conveying search results from at least two sources, thereby creating a more efficient human-machine interface.

The device displays (502) a user interface for an email application, where the user interface comprises a search field (e.g., search field 402 in FIGS. 4A-4I). In some embodiments, the user interface further comprises (504) a display board, where the display board lists a plurality of email messages (e.g., an email inbox, or a listing of emails in a folder or under a particular label). The device detects (506) user entry of a portion of a search term in the search field, where the portion of a search term comprises at least one character (e.g., “pet” in search field 402 in FIG. 4B).

The device performs several operations in response to detecting user entry of the portion of a search term in the search field. The device displays (508) a recommended search completion term in the search field. In some embodiments the recommended search completion term comprises the portion of a search term (e.g., “peter” in FIG. 4B comprising “pet”). The device displays (510) in a graphical overlay panel, the graphical overlay panel overlaid on a portion of the user interface, a plurality of search results, where the plurality of search results includes search results from a plurality of sources, and where the plurality of sources includes at least two sources selected from the group consisting of: contact information, email messages, documents, calendar entries, email labels, recent searches and web searches. In some embodiments, the search results are added to or removed (512) from the plurality of search results in the graphical overlay panel in response to the addition or removal of characters from the portion of the search term in the search field entered by a user (e.g., adding a character to search field 402 in FIG. 4F). In some embodiments, displaying (514) the plurality of search results in the graphical overlay panel includes displaying a subset of the text from the content of a respective search result, for one or more search results in the plurality of search results.

In some embodiments, each instance of the portion of the search term is highlighted (516) in one or more search results in the plurality of search results displayed in the graphical overlay panel (e.g., highlighted portion of the search term “pet” 426 in FIG. 4B). In some embodiments, each instance of the recommended search completion term is highlighted (518) in one or more search results in the plurality of search results displayed in the graphical overlay panel (e.g., highlighted portion of the search term “peter” 428 in FIG. 4B). In some embodiments, at least a subset of the search results in the plurality of search results in the graphical overlay panel is ordered (520) or reverse ordered by a respective date associated with each search result in the subset of search results (e.g., search results in graphical overlay panel 120 in FIG. 4E). In some embodiments, the plurality of search results in the graphical overlay panel is grouped into two or more subsets (522), each subset in the two or more subsets uniquely representing a different source in the plurality of sources. In some embodiments, displaying (524) the plurality of search results further comprises displaying a respective icon corresponding to the source for each respective search result in the plurality of search results.

In some embodiments, displaying (526) the plurality of search results in the graphical overlay panel includes displaying a respective date associated with each search result in the subset of search results. In some embodiments, the graphical overlay panel has (528) a degree of opacity between 30% and 100%. In some embodiments, the graphical overlay panel comprises (530) affordances to allow sorting of the plurality of search results by source or by dates associated with search results in the plurality of search results. In some embodiments, the graphical overlay panel displays (532) up to a predetermined number of search results, and comprises an affordance to allow display of additional search results.

In some embodiments, the device detects (534) user selection of a respective search result in the plurality of search results. In some embodiments, the device determines (536) if the selected search result is associated with the email application. In some embodiments, in response to determining that the selected search result is associated with the email application, the device opens (538) the search result in the email application. In some embodiments, in response to determining that the selected search result is associated with a second application, distinct from the email application, the device opens (540) the search result in the second application. In some embodiments, the device displays (542) one or more recommended search completion terms in the graphical overlay panel (e.g., terms 430 and 432 in FIG. 4E).

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the implementation(s). In general, structures and functionality presented as separate components in the example configurations may be implemented as a combined structure or component. Similarly, structures and functionality presented as a single component may be implemented as separate components. These and other variations, modifications, additions, and improvements fall within the scope of the implementation(s).

It will also be understood that, although the terms “first,” “second,” etc. may be used herein to describe various elements, these elements should not be limited by these terms. These terms are only used to distinguish one element from another. For example, a first message cluster could be termed a second message cluster, and, similarly, a second message cluster could be termed a first message cluster, without changing the meaning of the description, so long as all occurrences of the “first message cluster” are renamed consistently and all occurrences of the “second message cluster” are renamed consistently. The first message cluster and the second message cluster are both message clusters, but they are not the same message cluster.

The terminology used herein is for the purpose of describing particular implementations only and is not intended to be limiting of the claims. As used in the description of the implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined (that a stated condition precedent is true)” or “if (a stated condition precedent is true)” or “when (a stated condition precedent is true)” may be construed to mean “upon determining” or “in response to determining” or “in accordance with a determination” or “upon detecting” or “in response to detecting” that the stated condition precedent is true, depending on the context.

The foregoing description included example systems, methods, techniques, instruction sequences, and computing machine program products that embody illustrative implementations. For purposes of explanation, numerous specific details were set forth in order to provide an understanding of various implementations of the inventive subject matter. It will be evident, however, to those skilled in the art that implementations of the inventive subject matter may be practiced without these specific details. In general, well-known instruction instances, protocols, structures and techniques have not been shown in detail.

The foregoing description, for purpose of explanation, has been described with reference to specific implementations. However, the illustrative discussions above are not intended to be exhaustive or to limit the implementations to the precise forms disclosed. Many modifications and variations are possible in view of the above teachings. The implementations were chosen and described in order to best explain the principles and their practical applications, to thereby enable others skilled in the art to best utilize the implementations and various implementations with various modifications as are suited to the particular use contemplated.

What is claimed is:

1. A method for conveying search results, at a computing device having one or more processors and memory storing one or more programs for execution by the one or more processors, comprising:
displaying a user interface for an email application, wherein the user interface comprises a search field;
detecting user entry of a portion of a search term in the search field, wherein the portion of the search term comprises at least one character;
in response to detecting user entry of the portion of a search term in the search field:
displaying a recommended search completion term;
displaying, in a graphical overlay panel that is overlaid on a portion of the user interface, a plurality of search results, the plurality of search results including search results from a plurality of sources, wherein the plurality of sources includes at least two sources independently selected from the group consisting of: contact information, email messages, documents, calendar entries, email labels, recent searches and web searches.

2. The method of claim 1, wherein the user interface further comprises a display board that lists a plurality of electronic messages.

3. The method of claim 1, the method further comprising adding one or more search results to or removing one or more search result from the plurality of search results in the graphical overlay panel in response to the addition or removal of characters from the portion of the search term in the search field entered by a user.

4. The method of claim 1, wherein displaying the plurality of search results in the graphical overlay panel includes displaying a subset of the text from the content of a respective search result, for one or more search results in the plurality of search results.

5. The method of claim 1, wherein each instance of the portion of the search term in one or more search results in the plurality of search results displayed in the graphical overlay panel is highlighted.

6. The method of claim 1, wherein each instance of the recommended search completion term in one or more search results in the plurality of search results displayed in the graphical overlay panel is highlighted.

7. The method of claim 1, wherein at least a subset of the search results in the plurality of search results in the graphical overlay panel is ordered or reverse ordered by a respective date associated with each respective search result in the subset of search results.

8. The method of claim 1, wherein the plurality of search results in the graphical overlay panel is grouped into two or more subsets, each subset in the two or more subsets uniquely representing a different source in the plurality of sources.

9. The method of claim 1, wherein displaying the plurality of search results further comprises displaying a respective icon corresponding to the source for each respective search result in the plurality of search results.

10. The method of claim 1, wherein displaying the plurality of search results in the graphical overlay panel includes displaying a respective date associated with each search result in the subset of search results.

11. The method of claim 1, further comprising:
detecting user selection of a respective search result in the plurality of search results;
determining if the selected search result is associated with the email application;
in response to determining that the selected search result is associated with the email application, opening the search result in the email application; and
in response to determining that the selected search result is associated with a second application, distinct from the email application, opening the search result in the second application.

12. The method of claim 1, further comprising:
displaying one or more recommended search completion terms in the graphical overlay panel.

13. The method of claim 1, wherein the graphical overlay panel has a degree of opacity between 30% and 99%.

14. The method of claim 1, wherein the graphical overlay panel comprises affordances to allow sorting of the plurality of search results by source or by dates associated with search results in the plurality of search results.

15. The method of claim 1, wherein the graphical overlay panel displays up to a predetermined number of search results, and comprises an affordance to allow display of additional search results.

16. A computing system, comprising:
one or more processors;
memory; and
one or more programs, wherein the one or more programs are stored in the memory and configured to be executed by the one or more processors, the one or more programs including instructions for:
displaying a user interface for an email application, wherein the user interface comprises a search field;
detecting user entry of a portion of a search term in the search field, wherein the portion of the search term comprises at least one character;
in response to detecting user entry of the portion of the search term in the search field:
displaying a recommended search completion term in the search field, wherein the recommended search completion term comprises the portion of the search term;
displaying, in a graphical overlay panel that is overlaid on the portion of the user interface, a plurality of search results, the plurality of search results including search results from a plurality of sources, wherein the plurality of sources includes at least two sources independently selected from the group consisting of: contact information, email messages, documents, calendar entries, email labels, recent searches and web searches.

17. The system of claim 16, wherein the user interface further comprises a display board that lists a plurality of electronic messages.

18. The system of claim 16, the one or more programs further including instructions for adding one or more search results to or removing one or more search result from the plurality of search results in the graphical overlay panel in response to the addition or removal of characters from the portion of the search term in the search field entered by a user.

19. A non-transitory computer readable storage medium storing one or more programs, the one or more programs comprising instructions, which when executed by a computing system with one or more processors, cause the computing system to execute a method of:
displaying a user interface for an email application, wherein the user interface comprises a search field;
detecting user entry of a portion of a search term in the search field, wherein the portion of the search term comprises at least one character;
in response to detecting user entry of the portion of a search term in the search field:
displaying a recommended search completion term in the search field, wherein the recommended search completion term comprises the portion of the search term;
displaying, in a graphical overlay panel that is overlaid on a portion of the user interface, a plurality of search results, the plurality of search results including search results from a plurality of sources, wherein the plurality of sources includes at least two sources independently selected from the group consisting of: contact information, email messages, documents, calendar entries, email labels, recent searches and web searches.

20. The non-transitory computer readable storage medium of claim 19, wherein the user interface further comprises a display board that lists a plurality of electronic messages.
